(19) United States
(12) Patent Application Publication
(10) Pub. No.: US 2024/0102734 A1
(43) Pub. Date: Mar. 28, 2024

(54) HEAT TREATMENT SYSTEM

(71) Applicants: NGK INSULATORS, LTD., Nagoya-Shi (JP); NGK KILNTECH, CORPORATION, Nagoya-Shi (JP)

(72) Inventors: Masashi TANAMURA, Nagoya-Shi (JP); Tomoaki OYAMA, Nagoya-Shi (JP); Takanori ISONO, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/460,751

(22) Filed: Sep. 5, 2023

(30) Foreign Application Priority Data
Sep. 22, 2022 (JP) 2022-151256

(51) Int. Cl. F27B 9/02; B65G 61/00; F27D 5/00

(52) U.S. Cl. CPC F27B 9/021; B65G 61/00; F27D 5/0068

(57) ABSTRACT

A heat treatment system may include a heat treatment furnace; a supply device; a stack device configured to stack saggars in an up-down direction; a first conveyor configured to convey the saggars to the heat treatment furnace; an unstack device configured to unstack the stacked saggars; a recovery device; and a second conveyor configured to convey the saggars from the heat treatment furnace to the unstack device. At least one of the recovery device and the supply device may include at least a first conveyor mechanism and a second conveyor mechanism. The recovery device may further include a first recovery unit disposed on the first conveying path and a second recovery unit disposed on the second conveying path, or the supply device may further include a first supply unit disposed on the first conveying path and a second supply unit disposed on the second conveying path.

### CROSS-REFERENCE TO RELATED APPLICATION

The present application claims priority to Japanese Patent Application No. 2022-151256, filed on Sep. 22, 2022, the entire contents of which are incorporated herein by reference.

### TECHNICAL FIELD

The disclosure herein relates to a technology for heat treating a material.

### BACKGROUND ART

Heat treatment furnaces (e.g., roller hearth kilns, pusher kilns, etc.) may be used to heat treat a material. For example, in order to heat treat a material such as powder in a heat treatment furnace, the material is accommodated in saggars for heat treatment. The saggars are used repeatedly. For example, Japanese Patent No. 7041300 describes an example of a heat treatment system including a supply device that supplies a material to saggars, a heat treatment furnace that heat treats the material in the saggars, and a recovery device that recovers the heat-treated material from the saggars. The saggars are conveyed through the supply device, the heat treatment furnace, and the recovery device, and repeatedly used for the heat treatment to the material in the heat treatment furnace.

In order to improve productivity, multiple saggars containing a material may be stacked in an up-down direction for heat treatment in a heat treatment furnace. To the contrary, when the material is supplied to the saggars and when the heat-treated material in the saggars is recovered, the saggars are not stacked. That is, the stack of saggars is conveyed through the heat treatment furnace, the saggars are unstacked after conveyed out of the heat treatment furnace, and then the heat-treated material is recovered from each saggar in the recovery device. Then, after the material is supplied to the saggars again by the supply device, the saggars are stacked again and conveyed into the heat treatment furnace.

### DESCRIPTION

### Summary

In the heat treatment system of Japanese Patent No. 7041300, the saggars are conveyed through the supply device, the heat treatment furnace, and the recovery device. To heat treat a material in stacked saggars in such a heat treatment system, the saggars are generally stacked and unstacked using a conveyor that conveys the saggars (e.g., a conveyor including conveyor rollers). Specifically, for unstacking a stack of two saggars, the upper saggar is held and the lower saggar is conveyed forward, and then the upper saggar is placed on the conveyor. Thus, the lower saggar is conveyed first, followed by the upper saggar. Then, the material in the saggars is recovered in the recovery device, a non-heat-treated material is supplied to the saggars in the supply device, and then the saggars are stacked. For stacking the saggars, the saggar conveyed first is lifted and held and the following saggar is conveyed forward, and when the following saggar comes right below the saggar on hold, the saggar on hold is stacked on top of the following saggar. Thus, in the resulting stack of saggars, the saggar conveyed first is located above the following saggar. In this way, the order of the saggars stacked in the up-down direction is switched between before the unstacking and after the stacking.

However, a user may sometimes wish to stack saggars in the up-down direction in a desired order. For example, in a case where a lid is placed on top of a saggar for heat treatment, the lid is placed only on top of the uppermost saggar among the stacked saggars. Therefore, using the saggars repeatedly for heat treatment may make the shape of the uppermost saggar differ from those of the lower saggars due to thermal deformation. In such cases, the saggar having the shape for placement of the lid must always be located at the top of a stack of saggars. In the conventional heat treatment system, the order of stacked saggars in the up-down direction is different between before the unstacking and after the stacking, so that the saggar on which the lid is to be placed cannot always be located at the top of the stack of saggars. As above, in the conventional heat treatment system, the saggars cannot be stacked in the up-down direction in a desired order.

The disclosure herein provides a technique that allows saggars to be stacked in an up-down direction in a desired order.

In a first aspect of the technology disclosed herein, a heat treatment system may comprise a heat treatment furnace including an entrance and an exit, and configured to heat treat a material in each of a plurality of saggars stacked in an up-down direction while the saggars are conveyed from the entrance to the exit; a supply device configured to supply a non-heat-treated material to each of the plurality of saggars in which the material is not accommodated; a stack device configured to stack the saggars in the up-down direction in which the material has been supplied by the supply device; a first conveyor configured to convey the saggars stacked in the up-down direction by the stack device to the entrance of the heat treatment furnace; an unstack device configured to unstack the saggars stacked in the up-down direction after the saggars exited from the exit of the heat treatment furnace; a recovery device configured to recover the material heat-treated in the heat treatment furnace from the saggars unstacked by the unstack device; and a second conveyor configured to convey the saggars exited from the exit of the heat treatment furnace to the unstack device. At least one of the recovery device and the supply device may comprise at least a first conveyor mechanism and a second conveyor mechanism, the first conveyor mechanism being configured to convey a first saggar of the plurality of saggars along a first conveying path, the second conveyor mechanism being configured to convey a second saggar of the plurality of saggars along a second conveying path, the second saggar being different from the first saggar, the second conveying path being different from the first conveying path. In a case where the recovery device comprises the first conveyor mechanism and the second conveyor mechanism, the recovery device may further comprise a first recovery unit disposed on the first conveying path and a second recovery unit disposed on the second conveying path, each of the first and second recovery units being configured to recover the material in corresponding one of the first saggar and the second saggar. In a case where the supply device comprises the first conveyor mechanism and the second conveyor mechanism, the supply device may further comprise a first supply unit disposed on the first conveying path and a second supply unit disposed on the second conveying path, each of the first and second supply units being configured to supply the material into corresponding one of the first saggar and the second saggar.

### BRIEF DESCRIPTION OF DRAWINGS

FIG. 1 shows a schematic diagram of a heat treatment system according to a first embodiment.

FIG. 2 is a block diagram showing a control system of the heat treatment system according to the first embodiment.

FIG. 3 is a schematic diagram of a heat treatment furnace in a longitudinal cross-sectional view along a plane parallel to a conveying direction of saggars.

FIG. 4 is a cross-sectional view along a line IV-IV in FIG. 3.

FIGS. 5A to 5E are a side view illustrating how saggars are stacked by a stack device.

FIGS. 6A to 6E are a side view illustrating how stacked saggars are unstacked by an unstack device.

FIG. 7 is a block diagram showing a control system of a recovery device according to the first embodiment.

FIG. 8 shows first and second conveying paths.

FIG. 9 shows a schematic diagram of a heat treatment system according to a second embodiment.

FIG. 10 shows a schematic diagram of a heat treatment system according to a third embodiment.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a first aspect of the technology disclosed herein, a heat treatment system may comprise a heat treatment furnace including an entrance and an exit, and configured to heat treat a material in each of a plurality of saggars stacked in an up-down direction while the saggars are conveyed from the entrance to the exit; a supply device configured to supply a non-heat-treated material to each of the plurality of saggars in which the material is not accommodated; a stack device configured to stack the saggars in the up-down direction in which the material has been supplied by the supply device; a first conveyor configured to convey the saggars stacked in the up-down direction by the stack device to the entrance of the heat treatment furnace; an unstack device configured to unstack the saggars stacked in the up-down direction after the saggars exited from the exit of the heat treatment furnace; a recovery device configured to recover the material heat-treated in the heat treatment furnace from the saggars unstacked by the unstack device; and a second conveyor configured to convey the saggars exited from the exit of the heat treatment furnace to the unstack device. At least one of the recovery device and the supply device may comprise at least a first conveyor mechanism and a second conveyor mechanism, the first conveyor mechanism being configured to convey a first saggar of the plurality of saggars along a first conveying path, the second conveyor mechanism being configured to convey a second saggar of the plurality of saggars along a second conveying path, the second saggar being different from the first saggar, the second conveying path being different from the first conveying path. In a case where the recovery device comprises the first conveyor mechanism and the second conveyor mechanism, the recovery device may further comprise a first recovery unit disposed on the first conveying path and a second recovery unit disposed on the second conveying path, each of the first and second recovery units being configured to recover the material in corresponding one of the first saggar and the second saggar. In a case where the supply device comprises the first conveyor mechanism and the second conveyor mechanism, the supply device may further comprise a first supply unit disposed on the first conveying path and a second supply unit disposed on the second conveying path, each of the first and second supply units being configured to supply the material into corresponding one of the first saggar and the second saggar.

According to the heat treatment system described above, at least one of the recovery device and the supply device comprises the first conveying path and the second conveying path, and thus the saggars are conveyed in parallel in the recovery device and/or the supply device. When the saggars are stacked again after the heat-treated material has been recovered from and a non-heat treated material has been supplied to the unstacked saggars, the above configuration allows the saggars to be stacked in a desired order regardless of the previous order of the saggars in the up-down direction.

In a second aspect of the technology disclosed herein according to the first aspect, the heat treatment system may further comprise a branch part disposed upstream of the first conveying path and the second conveying path, and configured to selectively send off each of the saggars to one of the first conveying path and the second conveying path; and a joining part disposed downstream of the first conveying path and the second conveying path, and configured to join the first conveying path and the second conveying path. In this configuration, the conveying path is kept unbranched except for a part of the entire conveying path between the branch part and the joining part. Therefore, the area where the saggars are conveyed in parallel is minimized, and thus the cost of the entire heat treatment system can be reduced.

In a third aspect of the technology disclosed herein according to the second aspect, the heat treatment system may further comprise an adjustment mechanism configured to adjust which of the first saggar conveyed along the first conveying path and the second saggar conveyed along the second conveying path is to be sent off to the joining part first. In this configuration, the send-off order of the saggars to the joining part can be suitably adjusted, and thus the saggars can be stacked in a desired order.

### EMBODIMENTS

### First Embodiment

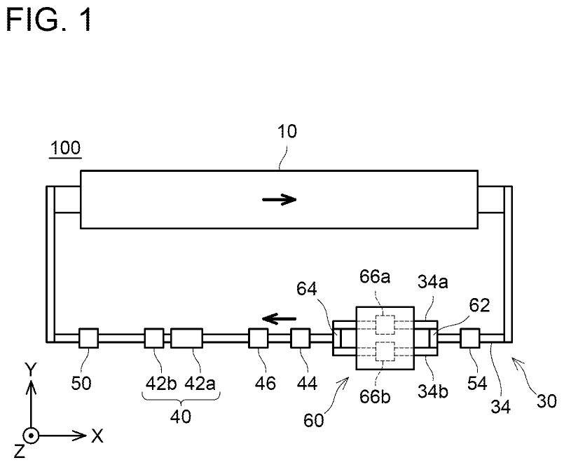

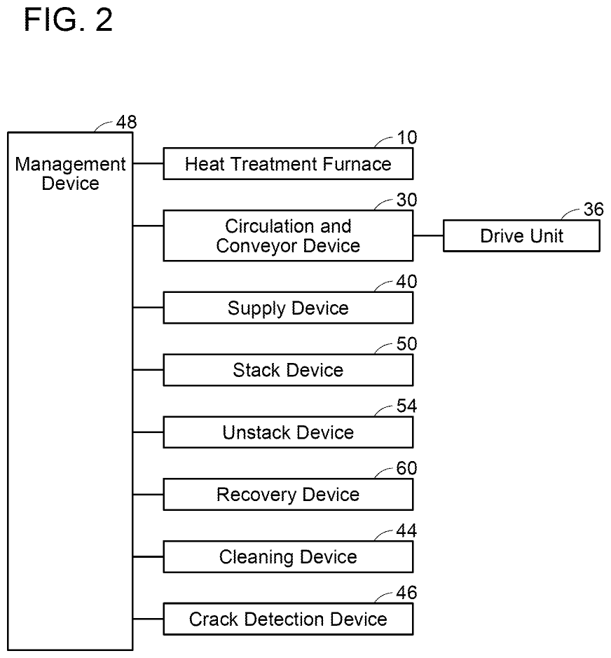

With reference to the drawings, a heat treatment system 100 according to the present embodiment is described. As shown in FIGS. 1 and 2, the heat treatment system 100 comprises a heat treatment furnace 10, a circulation and conveyor device 30, a supply device 40, a stack device 50, a unstack device 54, a recovery device 60, a cleaning device 44, a crack detection device 46, and a management device 48.

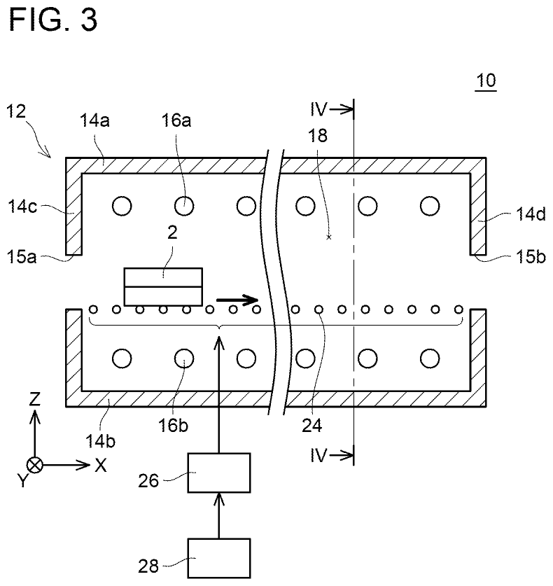

The heat treatment system 100 heat treats a material in saggars 2 (see FIG. 3). In this embodiment, the material in the saggars 2 is powder of a lithium-ion battery cathode material. In the heat treatment system 100 according to this embodiment, the saggars 2 circulate through the supply device 40, the stack device 50, the heat treatment furnace 10, the unstack device 54, the recovery device 60, the cleaning device 44, and the crack detection device 46. The material is heat treated while the saggars 2 are conveyed through the heat treatment furnace 10. As shown in FIG. 2, the management device 48 is connected to the heat treatment furnace 10, the circulation and conveyor device 30, the supply device 40, the stack device 50, the unstack device 54, the recovery device 60, the cleaning device 44, and the crack detection device 46. The management device 48 controls operations of the heat treatment furnace 10, the circulation and conveyor device 30, the supply device 40, the stack device 50, the unstack device 54, the recovery device 60, the cleaning device 44, and the crack detection device 46.

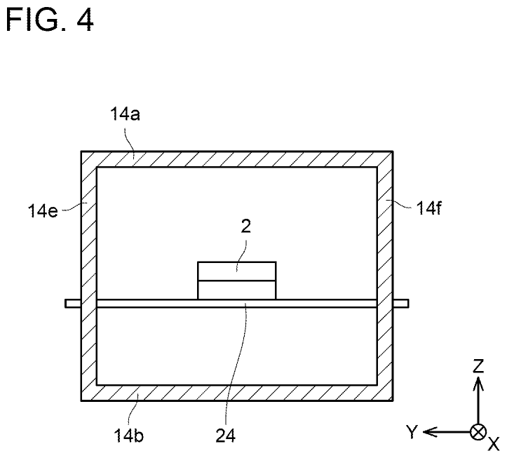

The heat treatment furnace 10 heat treats the material in the saggars 2. As shown in FIGS. 3 and 4, the heat treatment furnace 10 comprises a furnace body 12 and a conveyor (24, 26). The heat treatment furnace 10 heat treats the material in the saggars 2 while the saggars 2 are conveyed through the furnace body 12 by the conveyor (24, 26). In the heat treatment furnace 10 according to this embodiment, the multiple saggars 2 can be conveyed in a stacked state in an up-down direction (i.e., in the form of a stack of the multiple saggars 2).

The furnace body 12 has an outer shape of substantially cuboid, and a heat treatment space 18 therein is defined by a ceiling wall 14a, a bottom wall 14b, a furnace entrance wall 14c, a furnace exit wall 14d, and side walls 14e and 14f. As shown in FIG. 3, the ceiling wall 14a is parallel to the bottom wall 14b (i.e., parallel to XY plane). The furnace entrance wall 14c is located at one end of a conveying path and is perpendicular to a conveying direction (i.e., parallel to YZ plane). The furnace exit wall 14d is located at the other end of the conveying path and is parallel to the furnace entrance wall 14c (i.e., parallel to YZ plane). As shown in FIG. 4, the side walls 14e and 14f are parallel to the conveying direction and perpendicular to the ceiling wall 14a and the bottom wall 14b (i.e., parallel to XZ plane). A plurality of heaters 16a, 16b and a plurality of conveyor rollers 24 are disposed in the heat treatment space of the furnace body 12. The heaters 16a are located above the conveyor rollers 24 and are spaced apart from each other at predetermined intervals in the conveying direction, and the heaters 16b are located below the conveyor rollers 24 and are spaced apart from each other at predetermined intervals in the conveying direction. By the heaters 16a and 16b producing heat, the space 18 in the furnace body 12 and the material in the saggars 2 are heated. As shown in FIG. 3, an opening 15a is formed in the furnace entrance wall 14c and an opening 15b is formed in the furnace exit wall 14d. The saggars 2 are carried into the heat treatment furnace 10 through the opening 15a and carried out of the heat treatment furnace 10 through the opening 15b by the conveyor (24, 26). In other words, the opening 15a serves as an entrance of the heat treatment furnace 10 and the opening 15b serves as an exit of the heat treatment furnace 10.

The conveyor (24, 26) comprises the plurality of conveyor rollers 24 and a drive unit 26. The conveyor rollers 24 convey the saggars 2 placed on the conveyor rollers 24. The conveyor (24, 26) carries the saggars 2 into the heat treatment furnace 10 from the opening 15a and carries the saggars 2 out of the heat treatment furnace 10 from the opening 15b. The conveyor rollers 24 are each cylindrical, and their axes extend in a direction perpendicular to the conveying direction (i.e., in Y direction). The conveyor rollers 24 all have the same diameter and are equally spaced apart from each other in the conveying direction. The conveyor rollers 24 are supported such that they are rotatable about their axes and are rotated by drive power of the drive unit 26 being transmitted thereto. The drive unit 26 is a drive unit (e.g., a motor) configured to drive the conveyor rollers 24. The drive unit 26 is connected to the conveyor rollers 24 via a power transmission mechanism. When the drive power of the drive unit 26 is transmitted to the conveyor rollers 24 via the power transmission mechanism (e.g., a sprocket-chain mechanism), the conveyor rollers 24 are thereby rotated. The drive unit 26 drives each of the conveyor rollers 24 such that the conveyor rollers 24 rotate at approximately the same speed. The drive unit 26 is controlled by a controller 28. In the present embodiment, the conveyor rollers 24 all have the same diameter, but they may have different diameters. Conveyor rollers with different diameters may be installed in the heat treatment furnace 10. Further, in the present embodiment, the conveyor rollers 24 are equally spaced apart from each other at predetermined intervals, but they may be arranged differently. The conveyor rollers may be arranged at unequal intervals in the heat treatment furnace 10.

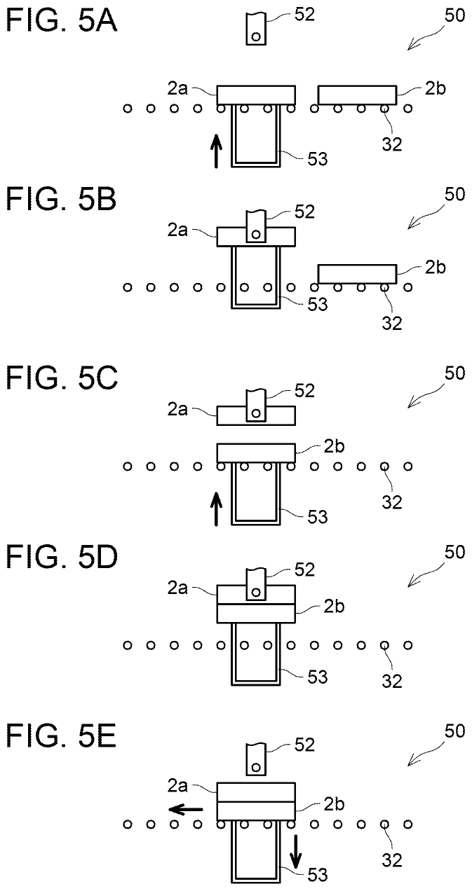

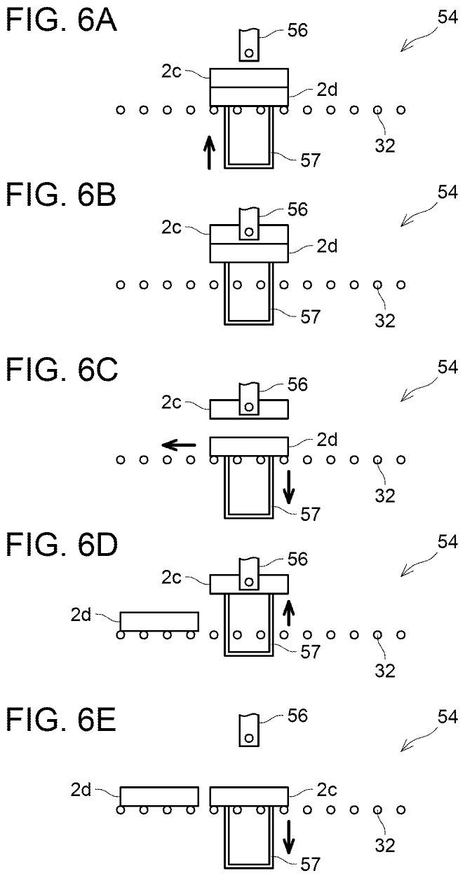

As shown in FIG. 1, the circulation and conveyor device 30 conveys the saggars 2 that exited from the exit (i.e., opening 15b) of the heat treatment furnace 10 to the entrance (i.e., opening 15a) of the heat treatment furnace 10 via the unstack device 54, the recovery device 60, the cleaning device 44, the crack detection device 46, the supply device 40, and the stack device 50. The circulation and conveyor device 30 comprises a plurality of conveyor rollers 32 (see FIGS. 5A to 5E and 6A to 6E) and a drive unit 36 (see FIG. 2). The conveyor rollers 32 are each cylindrical, and their axes extend in the direction perpendicular to the conveying direction. The conveyor rollers 32 all have the same diameter and are equally spaced apart from each other in the conveying direction. The conveyor rollers 32 are supported such that they are rotatable about their axes and are rotated by drive power of the drive unit 36 being transmitted thereto. The drive unit 36 is a drive unit (e.g., a motor) configured to drive the conveyor rollers 32. The drive unit 36 is connected to the conveyor rollers 32 via a power transmission mechanism. When the drive power of the drive unit 36 is transmitted to the conveyor rollers 32 via the power transmission mechanism (e.g., a sprocket-chain mechanism), the conveyor rollers 32 are thereby rotated. The drive unit 36 drives each of the conveyor rollers 32 such that the conveyor rollers 32 rotate at approximately the same speed. In the present embodiment, the conveyor rollers 32 all have the same diameter, but they may have different diameters. Conveyor rollers with different diameters may be installed on a conveying path 34 of the circulation and conveyor device 30. Further, in the present embodiment, the conveyor rollers 32 are equally spaced apart from each other, but they may be arranged differently. The conveyor rollers may be arranged at unequal intervals on the conveying path 34 of the circulation and conveyor device 30.

As shown in FIG. 1, the supply device 40 is located between the crack detection device 46 and the stack device 50. The supply device 40 comprises a first supplier 42a and a second supplier 42b. The first supplier 42a and the second supplier 42b are disposed on the conveying path 34 of the circulation and conveyor device 30. The first supplier 42a is located at an upstream section of the supply device 40 (at +X direction section in FIG. 1), and the second supplier 42b is located at a downstream section of the supply device 40 (at −X direction section in FIG. 1). The first supplier 42a and the second supplier 42b are arranged in series on the conveying path 34 of the circulation and conveyor device 30. That is, in the supply device 40, the saggars 2 are conveyed to the first supplier 42a first and then to the second supplier 42b.

The first supplier 42a and the second supplier 42b are devices that supply the material (i.e., powder) into the saggars 2. The first supplier 42a and the second supplier 42b have the same configuration. In one of the first supplier 42a and the second supplier 42b, the material is supplied into the saggars 2, whereas in the other, the material is not supplied into the saggars 2 and the saggars 2 just pass therethrough. The first supplier 42a and the second supplier 42b may have any configuration as long as they are configured to supply powder into the saggars 2, and their specific structures are not limited. For example, the first supplier 42a and the second supplier 42b each comprise a powder supplying part and a leveling part. Each powder supplying part is configured to supply the powder into the saggars 2. Specifically, each powder supplying part comprises a powder hopper that stores the powder, and the powder hopper includes a supply port through which the powder falls into the saggars 2 from above the saggars 2. The supply port is positioned such that it is located above the center of a saggar 2 when the saggar 2 is in the powder supplying part. Each powder supplying part comprises a positioner that positions a saggar 2, when it is conveyed to the powder supplying part, such that it is positioned below the supply port. Each powder supplying part may include a plurality of supply ports. Since each powder supplying part supplies the powder into a saggar 2 by dropping the powder from above, once the powder has been supplied into the saggar 2 in the powder supplying part, the top surface of the powder in the saggar 2 has a raised portion right below the supply port. Each leveling part levels the powder supplied into the saggar 2 by the powder supplying part. Specifically, each leveling part is configured to level the top surface of the powder by pressing a side surface of a flat plate against the top surface of the powder in the saggar 2. By leveling the top surface of the powder using the leveling part, the top surface of the powder in the saggar 2 becomes substantially horizontal.

The stack device 50 is disposed on the conveying path 34 of the circulation and conveyor device 30. The stack device 50 is located between the supply device 40 and the entrance of the heat treatment furnace 10. The stack device 50 stacks the saggars 2, to which the material has been supplied by the supply device 40, in an up-down direction. As shown in FIGS. 5A to 5E, the stack device 50 comprises a gripper 52 and an elevator 53. The gripper 52 grips a saggar 2 by contacting a pair of opposing surfaces of the saggar 2. That is, the gripper 52 can be opened and closed by an actuator, which is not shown. The gripper 52 grips the saggar 2 when closed, whereas the gripper 52 releases the saggar 2 when opened. The elevator 53 is located below the gripper 52, lifts a saggar 2 on the conveyor rollers 32 when it is conveyed to below the gripper 52, and lowers a saggar 2 onto the conveyor rollers 32. In this embodiment, the elevator 53 is a lifter, but it may have any configuration as long as it can lift and lower a saggar 2. For example, the elevator 53 may be a lifting pin. The elevator 53 can move upward and downward. When the elevator 53 moves upward, the upper end of the elevator 53 passes between the conveyor rollers 32 and then contacts a lower surface of the saggar 2 located above the elevator 53, thereby lifting the saggar 2.

How the stack device 50 stacks the saggars 2 is described here. As an example, stacking two saggars 2 is considered here. Hereinafter, for a purpose of distinguishing the two saggars 2, the saggar 2 that is to conveyed into the stack device 50 first is termed a saggar 2a, and the saggar 2 that is conveyed into the stack device 50 following the saggar 2a is termed a saggar 2b. For ease of explanation, how the stack device 50 stacks the two saggars 2a and 2b is described below as an example, however, the stack device 50 may stack three or more saggars 2.

The saggars 2a and 2b, to which the material has been supplied by the supply device 40, are conveyed into the stack device 50 by the conveyor rollers 32. In the supply device 40, the material is supplied to the saggars 2a and 2b in unstacked state. That is, the saggars 2a and 2b in unstacked state are conveyed into the stack device 50. Once the saggar 2a, which is conveyed into the stack device 50 first, is conveyed to below the gripper 52, the elevator 53 is moved upward (FIG. 5A). Then, the upper end of the elevator 53 contacts a lower surface of the saggar 2a, and the saggar 2a is lifted. Thus, the saggar 2a is separated from the conveyor rollers 32 and moved to above the conveyor rollers 32 (FIG. 5B). The gripper 52 then grips the saggar 2a. Once the saggar 2a is gripped by the gripper 52, the elevator 53 is moved downward. The elevator 53 is thus separated from the saggar 2a, which is being gripped by the gripper 52.

Next, the saggar 2b, which is conveyed into the stack device 50 following the saggar 2a, is conveyed to below the gripper 52 by the conveyor rollers 32. Once the saggar 2b is conveyed to below the gripper 52, the elevator 53 is moved upward (FIG. 5C). Then, the upper end of the elevator 53 contacts a lower surface of the saggar 2b, and the saggar 2b is lifted. When an upper surface of the saggar 2b contacts the lower surface of the saggar 2a (FIG. 5D), the gripper 52 releases the saggar 2a. After that, the elevator 53 is moved downward. Since the saggar 2a is no longer gripped by the gripper 52, when the elevator 53 is moved downward, the stack of the saggar 2a and the saggar 2b is placed back onto the conveyor rollers 32 (FIG. 5E). The stack of the saggars 2a and 2b is then conveyed out of the stack device 50 by the conveyor rollers 32. In this way, the stack device 50 stacks the plurality of saggars 2a and 2b such that the saggar 2a, which was conveyed into the stack device 50 first, is positioned above the saggar 2b, which was conveyed into the stack device 50 following the saggar 2a.

As shown in FIG. 1, the unstack device 54 is disposed on the conveying path 34 of the circulation and conveyor device 30. The unstack device 54 is located between the exit of the heat treatment furnace 10 and the recovery device 60. The unstack device 54 unstacks a stack of the saggars 2 stacked in the up-down direction. As shown in FIGS. 6A to 6E, the unstack device 54 comprises a gripper 56 and an elevator 57. The gripper 56 grips a saggar 2 by contacting a pair of opposing side surfaces of the saggar 2. That is, the gripper 56 can be opened and closed by an actuator, which is not shown. The gripper 56 grips the saggar 2 when closed, whereas the gripper 56 releases the saggar 2 when opened. The elevator 57 is located below the gripper 56, lifts a saggar 2 on the conveyor rollers 32 when it is conveyed to below the gripper 56, and lowers a saggar 2 onto the conveyor rollers 32. In this embodiment, the elevator 57 is a lifter, but it may have any configuration as long as it can lift and lower a saggar 2. For example, the elevator 57 may be a lifting pin. The elevator 57 can move upward and downward. When the elevator 57 moves upward, the upper end of the elevator 57 passes between the conveyor rollers 32 and contacts a lower surface of the saggar 2 located above the elevator 57, thereby lifting the saggar 2.

How the unstack device 54 unstacks a stack of the saggars 2 is described. As an example, unstacking a stack of two saggars 2 is described here. Hereinafter, for a purpose of distinguishing the two saggars 2, the upper saggar 2 in the stack of saggars 2 is termed a saggar 2c, and the lower saggar 2 is termed a saggar 2d. For ease of explanation, how the stack of the two saggars 2c and 2d is unstacked is described below as an example, however, the unstack device 54 may unstack a stack of three or more saggars 2.

After conveyed out of the heat treatment furnace 10, the stack of saggars 2c, 2d is conveyed into the unstack device 54 by the conveyor rollers 32. Once the stack of saggars 2c, 2d is conveyed to below the gripper 56, the elevator 57 is moved upward (FIG. 6A). Then, the upper end of the elevator 57 contacts a lower surface of the saggar 2d, which is positioned at the bottom of the stack, and the stack of saggars 2c, 2d is lifted (FIG. 6B). The gripper 56 then grips the upper saggar 2c.

Once the gripper 56 grips the saggar 2c, the elevator 57 is moved downward. As a result, the saggar 2c, which is being gripped by the gripper 56, stays above the conveyor rollers 32, and only the lower saggar 2d, which is not being gripped by the gripper 56, is lowered (FIG. 6C). Once the saggar 2d is placed back onto the conveyor rollers 32, the saggar 2d is conveyed forward by the conveyor rollers 32. That is, the saggar 2d is conveyed forward first. Next, the elevator 57 is moved upward again (FIG. 6D). When the upper end of the elevator 57 contacts a lower surface of the saggar 2c, the gripper 56 releases the saggar 2c. The elevator 57 is then moved downward. Since the saggar 2c is no longer gripped by the gripper 56, the saggar 2c is moved downward together with the elevator 57 and is then placed onto the conveyor rollers 32 (FIG. 6E). The saggar 2d is conveyed out of the unstack device 54 first, and the saggar 2c is conveyed out of the unstack device 54 following the saggar 2d, by the conveyance rollers 32. In this way, the unstack device 54 unstacks the stack of saggars 2c, 2d such that the lower saggar 2d is conveyed forward first and the upper saggar 2c is conveyed forward following the saggar 2d.

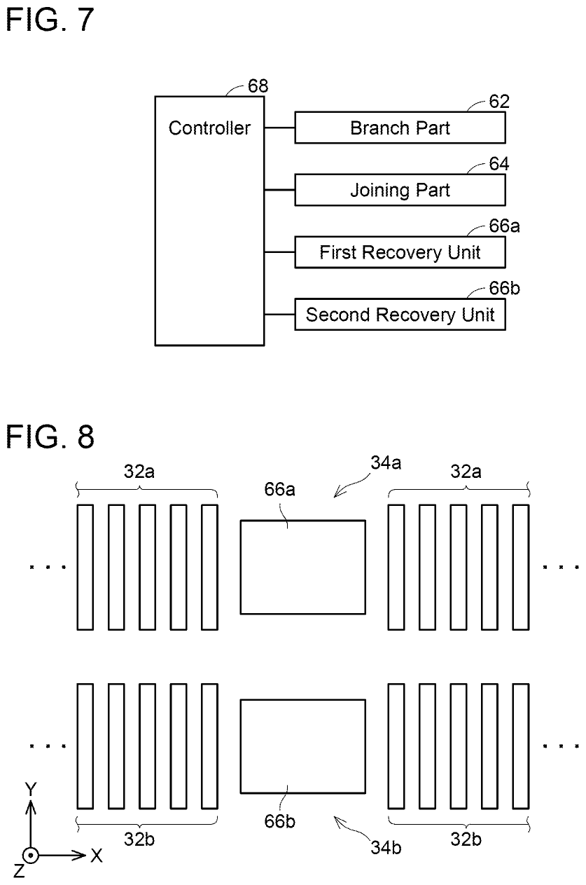

As shown in FIG. 1, the recovery device 60 is located between the unstack device 54 and the cleaning device 44. As shown in FIGS. 1 and 7, the recovery device 60 comprises a branch part 62, a joining part 64, a first recovery unit 66a, a second recovery unit 66b, and a controller 68.

The branch part 62 is disposed at an upstream section of the recovery device 60 and selectively sends off the saggars 2 on the conveying path 34 of the circulation and conveyor device 30 onto one of a first conveying path 34a and a second conveying path 34b. The joining part 64 is disposed at a downstream section of the recovery device 60 and sends off the saggars 2 conveyed on the first and second conveying paths 34a and 34b onto the conveying path 34 of the circulation and conveyor device 30. The first conveying path 34a and the second conveying path 34b are disposed in the recovery device 60. The first conveying path 34a and the second conveying path 34b are disposed between the branch part 62 and the joining part 64. At the branch part 62, the conveying path 34 of the circulation and conveyor device 30 branches off to the first conveying path 34a and the second conveying path 34b. At the joining part 64, the first conveying path 34a and the second conveying path 34b join into the conveying path 34 of the circulation and conveyor device 30.

As shown in FIG. 8, a plurality of conveyor rollers 32a is disposed on the first conveying path 34a (hereinafter, the conveyor rollers 32a on the first conveying path 34a may be referred to as “first conveyor rollers 32a”). The first conveyor rollers 32a are arranged upstream and downstream of the first recovery unit 66a, and are spaced apart from each other in a direction parallel to the conveying path 34 of the circulation and conveyor device 30 (in X direction in FIG. 8). The first conveying path 34a is parallel to the conveying path 34 of the circulation and conveyor device 30. Further, as shown in FIG. 1, the first conveying path 34a is offset in +Y direction relative to the conveying path 34 of the circulation and conveyor device 30.

As shown in FIG. 8, a plurality of conveyor rollers 32b is disposed on the second conveying path 34b (hereinafter, the conveyor rollers 32b on the second conveying path 34b may be referred to as “second conveyor rollers 32b”). The second conveyor rollers 32b are arranged upstream and downstream of the second recovery unit 66b, and are spaced apart from each other in the direction parallel to the conveying path 34 of the circulation and conveyor device 30 (in X direction in FIG. 8). The second conveying path 34b is parallel to the conveying path 34 of the circulation and conveyor device 30. Further, as shown in FIG. 1, the second conveying path 34b is offset in −Y direction relative to the conveying path 34 of the circulation and conveyor device 30. That is, the second conveying path 34b is parallel to the first conveying path 34a, and the first conveying path 34a and the second conveying path 34b are arranged in parallel with each other.

The first recovery unit 66a is disposed on the first conveying path 34a, and the second recovery unit 66b is disposed on the second conveying path 34b. As mentioned above, the first and second conveying paths 34a and 34b are in parallel with each other, and thus the first and second recovery units 66a and 66b are also in parallel with each other.

The first recovery unit 66a and the second recovery unit 66b are devices that recover the material (i.e., powder) that has been heat treated in the heat treatment furnace 10 from the saggars 2. The first recovery unit 66a and the second recovery unit 66b have the same configuration. The first recovery unit 66a and the second recovery unit 66b may have ay configuration as long as they are configured to recover powder from the saggars 2, and their specific structures are not limited. For example, the first recovery unit 66a and the second recovery unit 66b each comprise an inversion mechanism that inverts the saggars 2 upside down to recover the heat-treated material and an air recovery mechanism that recovers the heat-treated material (in this embodiment, powder) adhering to surfaces of the saggars 2 by peeling it off with air. Each inversion mechanism inverts a saggar 2 upside down to transfer the powder in the saggar 2 into a recovery container. As a result, almost all of the powder in the saggar 2 is transferred into the recovery container. Thereafter, the inversion mechanism inverts the saggar 2 upside down again to return it to its original orientation. The air recovery mechanism is used after the powder in the saggar 2 has been recovered by the inversion mechanism. The air recovery mechanism blows air onto the inner surface of the saggar 2 while suctioning air inside the saggar 2. By blowing air onto the inner surface of the saggar 2, the powder adhering to the inner surface of the saggar 2 is peeled off from the inner surface. Suctioning air in the saggar 2 while blowing air onto the inner surface of the saggar 2 allows the powder peeled off from the inner surface of the saggar 2 to be suctioned together with the air. Thus, the powder remaining on the inner surface of the saggar 2 is recovered and a powder recovery rate is increased. In the above example, the first recovery unit 66a and the second recovery unit 66b each comprise the air recovery mechanism, but they are not limited to such a configuration. For example, the powder remaining on the inner surface of the saggar 2 may be peeled off from the inner surface of the saggar 2 with a rotating brush to be recovered.

As shown in FIG. 7, the controller 68 is connected to the branch part 62, the joining part 64, the first recovery unit 66a, and the second recovery unit 66b. The controller 68 controls operations of the branch part 62, the joining part 64, the first recovery unit 66a, and the second recovery unit 66b.

How the heat-treated material in the saggars 2 is recovered in the recovery device 60 is described. The saggars 2 are conveyed by the conveyor rollers 32 from the unstack device 54 to the branch part 62 (see FIG. 1). As described above, a stack of saggars 2 is unstacked in the unstack device 54. Therefore, the unstacked saggars 2 are conveyed to the branch part 62. The branch part 62 selectively sends off each of the saggars 2 to one of the first conveying path 34a and the second conveying path 34b in accordance with instructions from the controller 68. For example, the controller 68 instructs the branch part 62 to send off a first saggar 2 to the first conveying path 34a and a second saggar 2 following the first saggar 2 to the second conveying path 34b.

When the first saggar 2, which has been sent off to the first conveying path 34a, is conveyed to the first recovery unit 66a by the first conveyor rollers 32a, the heat-treated material in the first saggar 2 is recovered by the first recovery unit 66a. Thereafter, the first saggar 2 is conveyed to the joining part 64 by the first conveyance rollers 32a. Similarly, when the second saggar 2, which has been sent off to the second conveying path 34b, is conveyed to the second recovery unit 66b by the second conveyor rollers 32b, the heat-treated material in the second saggar 2 is recovered by the second recovery unit 66b. Thereafter, the second saggar 2 is conveyed to the joining part 64 by the second conveyor rollers 32b. Thus, the two saggars 2, which were separated by the branch part 62 to the first conveying path 34a and the second conveying path 34b and conveyed thereon, join at the joining part 64.

Next, the controller 68 sends off the two saggars 2 at the joining part 64 (i.e., the first saggar 2 conveyed on the first conveying path 34a and the second saggar 2 conveyed on the second conveying path 34b) onto the conveying path 34 of the circulation and conveyor device 30 in a predetermined order. Which of the saggars 2 is positioned higher in a stack of the saggars 2 to be formed in the stack device 50 depends on which of the saggars 2 is sent off first from the joining part 64 onto the conveying path 34 of the circulation and conveyor device 30.

The relationship between the order in which the saggars 2 are conveyed out of the recovery device 60 and the order of the saggars 2 in the up-down direction in a stack of the saggars 2 to be formed in the stack device 50 is described in more detail. After conveyed out from the recovery device 60, the saggars 2 are conveyed through the cleaning device 44, the crack detection device 46, and the supply device 40 on the conveying path 34 of the circulation and conveyor device 30 and then conveyed into the stack device 50. As shown in FIGS. 5A to 5E, the stack device 50 stacks the saggars 2 such that the saggar 2a conveyed into the stack device 50 first is positioned higher than the saggar 2b conveyed into the stack device 50 following the saggar 2a. In the recovery device 60, when the first saggar 2 conveyed on the first conveying path 34a and the second saggar 2 conveyed on the second conveying path 34b join at the joining part 64, the order of the saggars 2 is adjusted such that the saggar 2 to be positioned higher in the stack is sent off first onto the conveying path 34 of the circulation and conveyor device 30 and the saggar 2 to be positioned lower in the stack is sent off later onto the conveying path 34 of the circulation and conveyor device 30. By adjusting the send-off order of saggars 2 onto the conveying path 34 of the circulation and conveyor device 30 at the joining part 64, the multiple saggars 2 can be stacked in the up-down direction in a desired order.

For example, in a conventional heat treatment system, the saggars 2 are conveyed on the conveying path 34 of the circulation and conveyor device 30 even in the recovery device. In other words, in the conventional heat treatment system, the saggars 2 are conveyed in series in the recovery device. In this case, when the saggars 2 are stacked again after conveyed out of the supply device, the saggars 2 are stacked in the reverse order to the previous order of the saggars 2 in the stack before the stack is conveyed into the unstack device. That is, as shown in FIGS. 6A to 6E, in the unstack device 54, the saggars 2 are unstacked such that the lower saggar 2d is conveyed forward first and the upper saggar 2c is then conveyed forward following the lower saggar 2d. The saggars 2d and 2c are conveyed through the recovery device, the cleaning device, the crack detection device, and the supply device, and then into the stack device 50. At this time, the saggar 2d is conveyed into the stack device 50 first, followed by the saggar 2c. As shown in FIGS. 5A to 5E, in the stack device 50, the saggars 2 are stacked such that the saggar 2d (saggar 2a in FIGS. 5A to 5E), which was conveyed into the stack device 50 first, is positioned higher than the saggar 2c (saggar 2b in FIGS. 5A to 5E), which was conveyed into the stacking device 50 following the saggar 2d, in the stack. Thus, the saggars 2c and 2d are stacked in the up-down direction in the reverse order to the order of them in the stack before unstacking (i.e., the order shown in FIG. 6A).

In the present embodiment, the send-off order of the saggars 2 onto the conveying path 34 of the circulation and conveyor device 30 is adjusted at the joining part 64, so that the saggars 2 can be stacked in the up-down direction in a desired order. For example, the saggars 2 may have different shapes depending on their positions in a stack. Specifically, the uppermost saggar 2 may allow a lid to be placed thereon. This saggar 2, which is shaped to allow the lid to be placed thereon, may have a different shape from other saggars 2 that do not allow lids to be placed thereon (i.e., saggars 2 on which another saggar 2 is placed). Even in a case where a lid is not placed on the uppermost saggar 2, the uppermost saggar 2 may not have a notch in its side surface, whereas the lower saggars 2 may have notches in their side surfaces. The notches are formed to release gases generated from the material during heat treatment. The uppermost saggar 2 is open upward because no lids are placed thereon, and thus a notch is unnecessary in the uppermost saggar 2. As above, each saggar 2 may sometimes be required to be at its specific position in the up-down direction in a stack of saggars 2 according to the types of saggars 2, and thus each saggar 2 may need to be adjusted such that they are stacked in their appropriate positions. Even in a case where the saggars 2 have the same shape, the order of the saggars 2 in the up-down direction may be changed to a desired order. For example, the lowermost saggar 2 is more likely to deteriorate than the upper saggars 2 because it becomes worn by contact with the conveyor rollers 32 while conveyed. In order to prevent only a certain saggar 2 from deteriorating, the order of the saggars 2 in the up-down direction may be changed upon stacking. In the present embodiment, the order of the saggars 2 in the up-down direction can be easily adjusted by adjusting the send-off order of the saggars 2 onto the conveying path 34 of the circulation and conveyor device 30 at the joining part 64. That is, by the simple adjustment, the saggars can be stacked in the same order every stacking, and also the saggars can be stacked in different orders every stacking.

The cleaning device 44 cleans inner surfaces of the saggars 2 after the heat-treated material (i.e., powder) has been recovered in the recovery device 60. The cleaning device 44 may have any configuration as long as it is configured to clean the inner surfaces of the saggars 2, and its specific structure is not limited. For example, the cleaning device 44 suctions air, etc. inside the saggars 2 while peeling off substances adhering to the inner surfaces of the saggars 2 with a rotating brush. The suctioned air, etc. contains the peeled-off substances. By cleaning the inner surfaces of the saggars 2 with the cleaning device 44, the powder, etc. remaining on the inner surfaces of the saggars 2 can be completely removed.

The crack detection device 46 inspects whether the saggars 2 are cracked or not by detecting cracks on the saggars 2. The saggars 2 are repeatedly used to heat treat the material in the heat treatment furnace 10. After the saggars 2 are used for heat treatment of the material in the heat treatment furnace 10, the crack detection device 46 inspects whether the saggars 2 are cracked or not before they are used again. The crack detection device 46 may have any configuration as long as it is configured to detect cracks on the saggars 2, and its specific configuration is not limited. For example, the crack detection device 46 may detect cracks on the saggars 2 using a laser. The crack detection device 46 may also detect cracks on the saggars 2 by filling the saggars 2 with gas and measuring the pressure in the saggars 2. If it is detected that a saggar 2 is cracked, the saggar 2 is removed from the conveying path 34 of the circulation and conveyor device 30. If it is detected that a saggar 2 is not cracked, the saggar 2 is conveyed to the supply device 40 by the circulation and conveyor device 30.

In the present embodiment, the circulation and conveyor device 30 is a roller conveyor that conveys the saggars 2 by means of the conveyor rollers 32, but it is not limited thereto. The circulation and conveyor device may have any configuration as long as it is configured to convey the saggars 2 that exited from the exit of the heat treatment furnace 10 to the entrance of the heat treatment furnace 10. For example, the circulation and conveyor device may be a belt conveyor that conveys the saggars 2 by means of a belt.

In the present embodiment, the controller 68 of the recovery device 60 adjusts the send-off order of the saggars 2 from the joining part 64 onto the conveying path 34 of the circulation and conveyor device 30, but another configuration may be employed. For example, the management device 48 may adjust the send-off order of the saggars 2 from the joining part 64 onto the conveying path 34 of the circulation and conveyor device 30.

In the present embodiment, only the saggars 2 are stacked, but a lid may be placed on top of the uppermost saggar 2. In this case, the lid may be unstacked in the unstack device 54 and placed on the conveying path 34 of the circulation and conveyor device 30, conveyed to the stack device 50 via the same route as the unstacked saggars 2, and then placed on top of the uppermost saggar 2 in the stack device 50. Alternatively, another conveying path may be disposed between the unstack device 54 and the stack device 50, and the lid unstacked in the unstack device 54 may be conveyed to the stack device 50 via the other conveying path.

### Second Embodiment

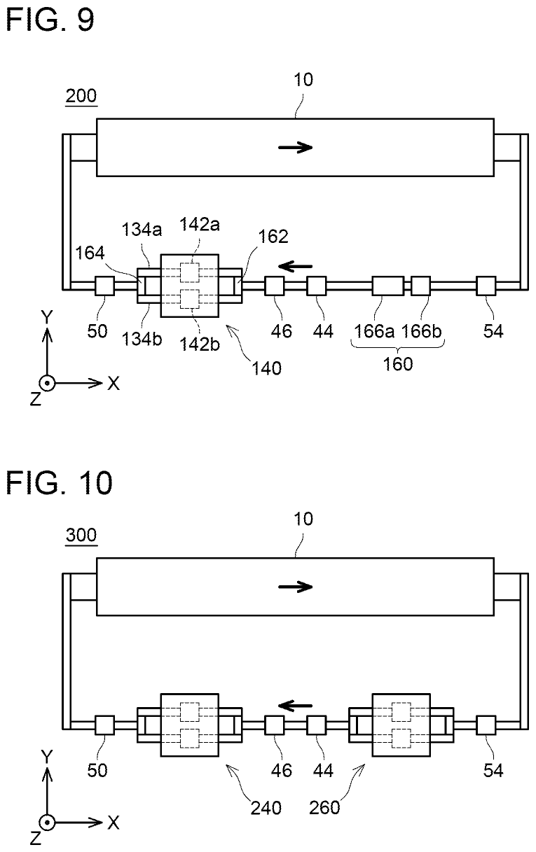

In the above embodiment, the first conveying path 34a and the second conveying path 34b are arranged in parallel with each other in the recovery device 60, but another configuration may be employed. Any configuration may be employed as long as it allows for an easy adjustment for the order of saggars 2 in the up-down direction when the saggars 2 unstacked in the unstack device 54 are stacked in the stack device 50. For example, as shown in FIG. 9, two conveying paths may be arranged in parallel with each other in a supply device 140, and two conveying paths may not be arranged in parallel with each other in a recovery device 160. The supply device 140 and the recovery device 160 of a heat treatment system 200 according to the present embodiment are different from the supply device 40 and the recovery device 60 of the heat treatment system 100 according to the first embodiment, but the other configurations are substantially the same. Therefore, the description for the same configurations as those of the heat treatment system 100 according to the first embodiment is omitted.

The supply device 140 comprises a branch part 162, a joining part 164, a first supply unit 142a, a second supply unit 142b, and a controller (not shown). The branch part 162 is located at an upstream section of the supply unit 140 and is configured to selectively send off the saggars 2 on the conveying path 34 of the circulation and conveyor device 30 onto one of a first conveying path 134a and a second conveying path 134b. The joining part 164 is located at a downstream section of the supply device 140 and is configured to join the saggars 2 on the first and second conveying paths 134a and 134b onto the conveying path 34 of the circulation and conveyor device 30. The first conveying path 134a and the second conveying path 134b are disposed in the supply device 140. The first conveying path 134a and the second conveying path 134b are disposed between the branch part 162 and the joining part 164. The first supply unit 142a is disposed on the first conveying path 134a, and the second supply unit 142b is disposed on the second conveying path 134b. The branch part 162, the joining part 164, the first conveying path 134a, and the second conveying path 134b have substantially the same configurations as the branch part 62, the joining part 64, the first conveying path 34a, and the second conveying path 34b in the recovery device 60 according to the first embodiment, and thus detailed description for them is omitted. Further, the first supply unit 142a and the second supply unit 142b also have substantially the same configurations as the first supply unit 42a and the second supply unit 42b according to the first embodiment, and thus detailed description for them is omitted. In the present embodiment, the first and second conveying paths 134a and 134b are arranged in parallel with each other in the supply device 140, and the first and second supply units 142a and 142b are also arranged in parallel with each other.

The recovery device 160 comprises a first recovery unit 166a and a second recovery unit 166b. The first recovery unit 166a and the second recovery unit 166b are disposed on the conveying path 34 of the circulation and conveyor device 30. That is, the first recovery unit 166a and the second recovery unit 166b are arranged in series on the conveying path 34 of the circulation and conveyor device 30. The first recovery unit 166a and the second recovery unit 166b have substantially the same configurations as the first recovery unit 66a and the second recovery unit 66b according to the first embodiment, and thus detailed description for them is omitted. Since the first recovery unit 166a and the second recovery unit 166b have the same configuration, the heat-treated material is recovered from the saggars 2 in one of the first recovery unit 166a and the second recovery unit 166b, whereas the heat-treated material is not recovered in the other and the saggars 2 just pass therethrough.

In the present embodiment, instead of two conveying paths being arranged in parallel with each other in the recovery device 160, the two conveying paths 134a and 134b are arranged in parallel with each other in the supply device 140. After unstacked in the unstack device 54, the saggars 2 are conveyed in series through the recovery device 160, the cleaning device 44, and the crack detection device 46, and then conveyed into the supply device 140. In the supply device 140, the saggars 2 are selectively sent off, by the branch part 162, to one of the two conveying paths 134a and 134b, and are conveyed thereon in parallel. At the joining part 164, the send-off order of the saggars 2 onto the conveying path 34 of the circulation and conveyor device 30 is adjusted. Thereafter, the saggars 2 are conveyed into the stack device 50 in the order adjusted at the joining part 164. Therefore, in the present embodiment as well, the order of the saggars 2 in the up-down direction in a stack can be easily adjusted by adjusting the send-off order of the saggars 2 onto the conveying path 34 of the circulation and conveyor device 30 at the joining part 64 of the supply device 140.

### Third Embodiment

In the first and second embodiments, the first conveying path 34a, 134a and the second conveying path 34b, 134b are disposed in parallel with each other in only one of the recovery device 60, 160 and the supply device 40, 140, but another configuration may be employed. For example, as shown in FIG. 10, in a heat treatment system 300, two conveying paths may be arranged in parallel with each other in each of a recovery device 260 and a supply device 240. The recovery device 260 has substantially the same configuration as that of the recovery device 60 according to the first embodiment, and the supply device 240 has substantially the same configuration as that of the supply device 140 according to the second embodiment. Therefore, detailed description for the recovery device 260 and the supply device 240 is omitted. In the present embodiment as well, the order of the saggars 2 in the up-down direction in a stack can be easily adjusted by adjusting the send-off order of the saggars 2 onto the conveying path 34 of the circulation and conveyor device 30 at the joining parts of the recovery device 260 and the supply device 240.

The following are some notes on the heat treatment systems 100, 200, and 300 described in the embodiments. The circulation and conveyor device 30 in the embodiments is an example of “first conveyor” and “second conveyor”, the conveyor mechanism using the conveyor rollers 32a is an example of “first conveyor mechanism”, the conveyor mechanism using the conveyor rollers 32b is an example of “second conveyor mechanism”, the first recovery units 66a, 166a and the second recovery unis 66b, 1 66b are examples of “recovery unit”, the first supply units 42a, 142a and the second supply units 42b, 142b are examples of “supply unit”, and the controller 68 is an example of “adjustment mechanism”.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment system comprising:
a heat treatment furnace including an entrance and an exit, and configured to heat-treat a material in each of a plurality of saggars stacked in an up-down direction while the saggars are conveyed from the entrance to the exit;
a supply device configured to supply a non-heat-treated material to each of the plurality of saggars in which the material is not accommodated;
a stack device configured to stack the saggars in the up-down direction in which the material has been supplied by the supply device;
a first conveyor configured to convey the saggars stacked in the up-down direction by the stack device to the entrance of the heat treatment furnace;
an unstack device configured to unstack the saggars stacked in the up-down direction after the saggars exited from the exit of the heat treatment furnace;
a recovery device configured to recover the material heat-treated in the heat treatment furnace from the saggars unstacked by the unstack device; and
a second conveyor configured to convey the saggars exited from the exit of the heat treatment furnace to the unstack device,
wherein
at least one of the recovery device and the supply device comprises at least a first conveyor mechanism and a second conveyor mechanism, the first conveyor mechanism being configured to convey a first saggar of the plurality of saggars along a first conveying path, the second conveyor mechanism being configured to convey a second saggar of the plurality of saggars along a second conveying path, the second saggar being different from the first saggar, the second conveying path being different from the first conveying path,
in a case where the recovery device comprises the first conveyor mechanism and the second conveyor mechanism, the recovery device further comprises a first recovery unit disposed on the first conveying path and a second recovery unit disposed on the second conveying path, each of the first and second recovery units being configured to recover the material in corresponding one of the first saggar and the second saggar, and
in a case where the supply device comprises the first conveyor mechanism and the second conveyor mechanism, the supply device further comprises a first supply unit disposed on the first conveying path and a second supply unit disposed on the second conveying path, each of the first and second supply units being configured to supply the material into corresponding one of the first saggar and the second saggar.

2. The heat treatment system according to claim 1, further comprising:
a branch part disposed upstream of the first conveying path and the second conveying path, and configured to selectively send off each of the saggars to one of the first conveying path and the second conveying path; and
a joining part disposed downstream of the first conveying path and the second conveying path, and configured to join the first conveying path and the second conveying path.

3. The heat treatment system according to claim 2, further comprising an adjustment mechanism configured to adjust which of the first saggar conveyed along the first conveying path and the second saggar conveyed along the second conveying path is to be sent off to the joining part first.
